(19) United States
(12) Patent Application Publication
(10) Pub. No.: US 2023/0394422 A1
(43) Pub. Date: Dec. 7, 2023

(54) Shipment Instruction Device and Shipment Instruction Method

(71) Applicant: Hitachi, Ltd., Chiyoda-ku, Tokyo (JP)

(72) Inventor: Satoshi NAGAHARA, Tokyo (JP)

(21) Appl. No.: 18/033,122

(22) PCT Filed: Oct. 14, 2021
(86) PCT No.: PCT/JP2021/038023

§ 371 Date: Apr. 21, 2023

(30) Foreign Application Priority Data
Dec. 8, 2020 (JP) 2020-203461

(51) Int. Cl. G06Q 10/0834

(52) U.S. Cl. CPC G06Q 10/0834

(57) ABSTRACT

A shipment instruction device according to the present invention: calculates a remaining capacity from a difference between a shippable quantity during the predetermined period and a quantity of a shipping order whose shipping deadline arrives during the predetermined period, the remaining capacity being a remaining shippable quantity during the predetermined period; generates a plurality of front-loaded shipping order group proposals including a shipping order whose shipping deadline arrives after the predetermined period within a range of the remaining capacity; calculates a quantity loadable during the predetermined period; calculates a shipping order group to be delivered in a period after the predetermined period for each front-loaded shipping order group proposal, based on the quantity of the shipping order whose shipping deadline arrives in the predetermined period, the quantity of the front-loaded shipping order group proposal, and the quantity loadable in the predetermined period; calculates a number of required delivery cargos for a quantity to be shipped in the period after the predetermined period based on a shipping order group to be delivered in the period after the predetermined period; and specifies, among the plurality of front-loaded shipping order group proposals, a front-loaded shipping order group proposal whose number of required delivery cargos is small.

### INCORPORATION BY REFERENCE

This application claims priority to Japanese Patent Application No. 2020-203461 filed on Dec. 8, 2020 (2020), the contents of which are incorporated herein by reference.

### TECHNICAL FIELD

The present invention relates to a shipment instruction device and a shipment instruction method.

### BACKGROUND ART

As a background art of the present invention, there is Japanese Patent Application Laid-Open No. 2016-212757 (PTL 1). This publication describes a method for reducing a difference between a maximum value and a minimum value of a total delivery amount of each day in a predetermined period by limiting a delivery destination and a delivery date of each product and front-loading the delivery of the product when a demand prediction of the product is given.

### CITATION LIST

### Patent Literature

PTL 1: Japanese Patent Application Laid-Open No. 2016-212757

### SUMMARY OF INVENTION

### Technical Problem

An object of the present invention is to improve delivery efficiency in logistics. In order to improve the delivery efficiency, it is important to reduce the number of delivery cargos required for delivering a certain quantity by improving the loading rate of each delivery cargo. On the other hand, the method described in PTL 1 is a method of leveling the total delivery amount of each day by front-loading the delivery of a specific product, and the number of delivery cargos cannot be reduced since the loading rate of each delivery cargo is not considered. Further, in order to deliver each product, it is necessary to perform shipping work of the product in the warehouse. Since there is a limit to the shipping work capability of the warehouse, when the delivery of a certain product is front-loaded, it is necessary to ensure that the shipping work of the product can be front-loaded within the range of the shipping work capability of the warehouse. From the above, it is a problem to present a shipping work instruction in the warehouse so as to improve the loading rate of the delivery cargo.

### Solution to Problem

In order to solve at least one of the above problems, a shipment instruction device of the present invention includes a control unit and a storage unit, wherein the storage unit holds shipping order information indicating a delivery destination, a quantity, and a shipping deadline of each shipping order, shipping work capability information indicating a shippable quantity of a warehouse in a predetermined period, delivery cargo information indicating a delivery cargo to each delivery destination in the predetermined period, and loadable capacity information indicating a loadable quantity of the delivery cargo, and the control unit: calculates, based on the shipping order information and the shipping work capability information, a remaining capacity from a difference between a shippable quantity during the predetermined period and a quantity of a shipping order whose shipping deadline arrives during the predetermined period, the remaining capacity being a remaining shippable quantity during the predetermined period; generates a plurality of front-loaded shipping order group proposals including a shipping order whose shipping deadline arrives after the predetermined period within a range of the remaining capacity; calculates a quantity loadable during the predetermined period based on the delivery cargo information and the loadable capacity information; calculates a shipping order group to be delivered in a period after the predetermined period for each front-loaded shipping order group proposal, based on the quantity of the shipping order whose shipping deadline arrives in the predetermined period, the quantity of the front-loaded shipping order group proposal, and the quantity loadable in the predetermined period; calculates a number of required delivery cargos for a quantity to be shipped in the period after the predetermined period based on a shipping order group to be delivered in the period after the predetermined period and the shipping order information; and specifies, among the plurality of front-loaded shipping order group proposals, a front-loaded shipping order group proposal whose number of required delivery cargos is small.

### Advantageous Effects of Invention

According to one aspect of the present invention, it is possible to prepare a shipping work instruction capable of reducing the number of delivery cargos. Problems, configurations, and effects other than those described above will be clarified by the following description of an embodiment.

### BRIEF DESCRIPTION OF DRAWINGS

FIG. 1 is a functional block diagram of a shipment instruction device according to an embodiment of the present invention.

FIG. 2 is an explanatory diagram of a shipping order data table according to the embodiment of the present invention.

FIG. 3 is an explanatory diagram of a shipping work capability data table according to the embodiment of the present invention.

FIG. 4 is an explanatory diagram of a delivery cargo data table according to the embodiment of the present invention.

FIG. 5 is an explanatory diagram of a loadable capacity data table according to the embodiment of the present invention.

FIG. 6 is an explanatory diagram of an expected shipping order data table according to the embodiment of the present invention.

FIG. 7 is a flowchart showing processing executed by a control unit according to the embodiment of the present invention.

FIG. 8 is an explanatory diagram illustrating an example of a display screen output by an output unit according to the embodiment of the present invention.

FIG. 9 is a schematic diagram of a shipment instruction system which is one embodiment of the present invention.

### DESCRIPTION OF EMBODIMENTS

Hereinafter, details of an embodiment of the present invention will be described.

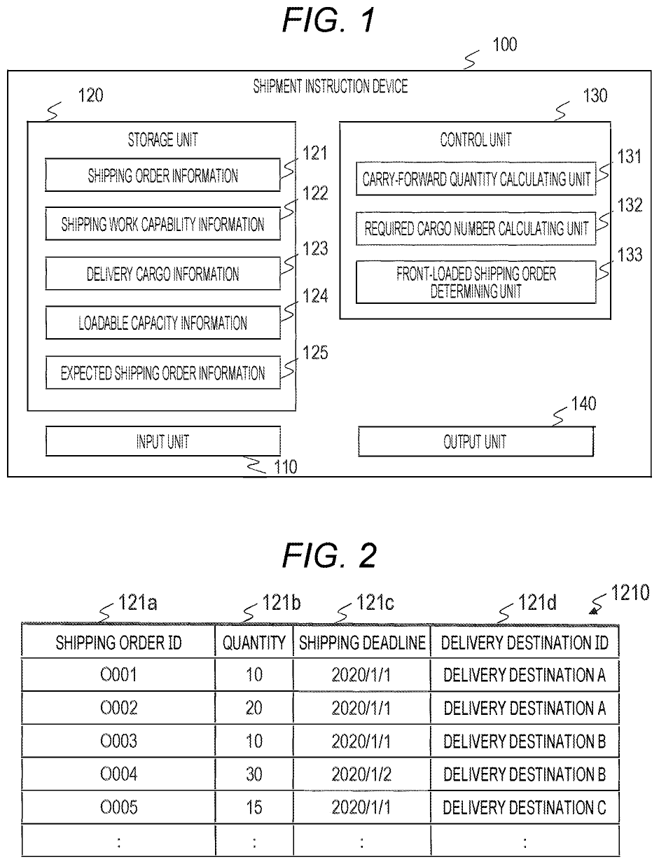

FIG. 1 is a functional block diagram of a shipment instruction device 100 according to an embodiment of the present invention.

As illustrated, the shipment instruction device 100 includes an input unit 110, a storage unit 120, a control unit 130, and an output unit 140.

The input unit 110 receives inputs of various types of information from the outside of the shipment instruction device 100.

The storage unit 120 holds a shipping order information storage area 121, a shipping work capability information storage area 122, a delivery cargo information storage area 123, a loadable capacity information storage area 124, and an expected shipping order information storage area 125.

The shipping order information storage area 121 stores information of each shipping order including information of a delivery destination and a shipping deadline. For example, in the present embodiment, a shipping order data table 1210 as illustrated in FIG. 2 is stored.

FIG. 2 is an explanatory diagram of the shipping order data table 1210 according to the embodiment of the present invention.

The shipping order data table 1210 includes a shipping order ID field 121a, a quantity field 121b, a shipping deadline field 121c, and a delivery destination ID field 121d. Information for specifying each shipping order is stored in the shipping order ID field 121a. Information for specifying a quantity of the shipping order is stored in the quantity field 121b. Information for specifying a shipping deadline of the shipping order is stored in the shipping deadline field 121c. Information for specifying a delivery destination of the shipping order is stored in the delivery destination ID field 121d.

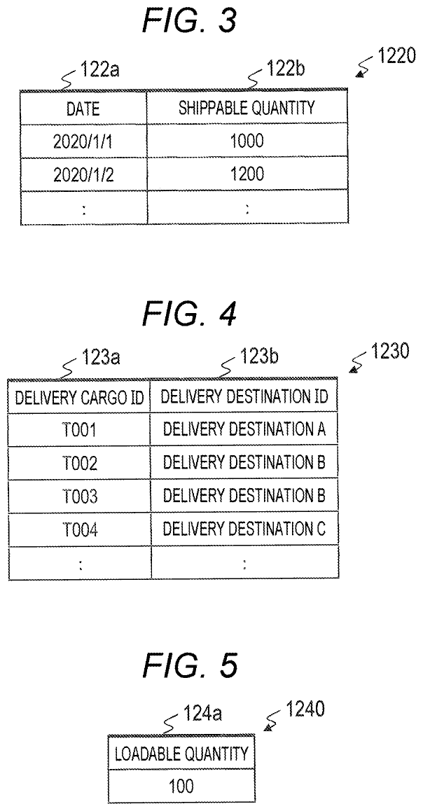

The shipping work capability information storage area 122 stores information for specifying the shipping work capability of the warehouse. For example, in the present embodiment, a shipping work capability data table 1220 as illustrated in FIG. 3 is stored.

FIG. 3 is an explanatory diagram of the shipping work capability data table 1220 according to the embodiment of the present invention.

The shipping work capability data table 1220 includes a date field 122a and a shippable quantity field 122b. Information for specifying a date is stored in the date field 122a. Information for specifying an upper limit value of the quantity for which shipping work can be carried out on the date is stored in the shippable quantity field 122b.

The delivery cargo information storage area 123 stores information for specifying a delivery cargo on the day. For example, in the present embodiment, a delivery cargo data table 1230 as illustrated in FIG. 4 is stored.

FIG. 4 is an explanatory diagram of the delivery cargo data table 1230 according to the embodiment of the present invention.

The delivery cargo data table 1230 includes a delivery cargo ID field 123a and a delivery destination ID field 123b. Information for specifying a delivery cargo (that is, a delivery cargo ID) is stored in the delivery cargo ID field 123a. For example, in the case of delivery by truck, one delivery cargo ID corresponds to one delivery by one truck. Information for specifying a delivery destination of the delivery cargo is stored in the delivery destination ID field 123b.

The loadable capacity information storage area 124 stores information for specifying a quantity of products that can be loaded on each delivery cargo. For example, in the present embodiment, a loadable capacity data table 1240 as illustrated in FIG. 5 is stored.

FIG. 5 is an explanatory diagram of the loadable capacity data table 1240 according to the embodiment of the present invention.

The loadable capacity data table 1240 includes a loadable quantity field 124a. Information for specifying a quantity that can be loaded on one delivery cargo is stored in the loadable quantity field 124a. In the present embodiment, the case where loadable quantities of all delivery cargos are the same is described, but the loadable quantity may be set for each type of delivery cargos, for example, and the present invention does not limit the method.

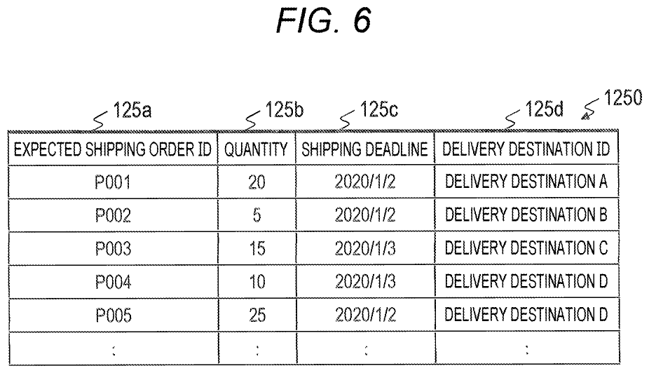

The expected shipping order information storage area 125 stores information for specifying a shipping order (that is, an expected shipping order) that has not been received yet but is expected to be received in the future (for example, the next day). For example, in the present embodiment, the expected shipping order data table 1250 as illustrated in FIG. 6 is stored.

FIG. 6 is an explanatory diagram of the expected shipping order data table 1250 according to the embodiment of the present invention.

The expected shipping order data table 1250 includes an expected shipping order ID field 125a, a quantity field 125b, a shipping deadline field 125c, and a delivery destination ID field 125d. Information for specifying each expected shipping order is stored in the expected shipping order ID field 125a. Information for specifying a quantity of the expected shipping order is stored in the quantity field 125b. Information for specifying a shipping deadline of the expected shipping order is stored in the shipping deadline field 125c. Information for specifying a delivery destination of the expected shipping order is stored in the delivery destination ID field 125d.

Again, FIG. 1 is referenced. The control unit 130 includes a carry-forward quantity calculating unit 131, a required cargo number calculating unit 132, and a front-loaded shipping order determining unit 133. For example, the control unit 130 may include a processor and a memory, and functions of the carry-forward quantity calculating unit 131, the required cargo number calculating unit 132, and the front-loaded shipping order determining unit 133 may be implemented by the processor executing a program stored in the memory. In this case, processing executed by each of the above units in the following description are actually executed by the processor. The processor may be configured by a single processing unit or multiple processing units, and may include one or multiple arithmetic units, or multiple processing cores. Alternatively, the carry-forward quantity calculating unit 131, the required cargo number calculating unit 132, and the front-loaded shipping order determining unit 133 may be respectively realized by dedicated logic circuits.

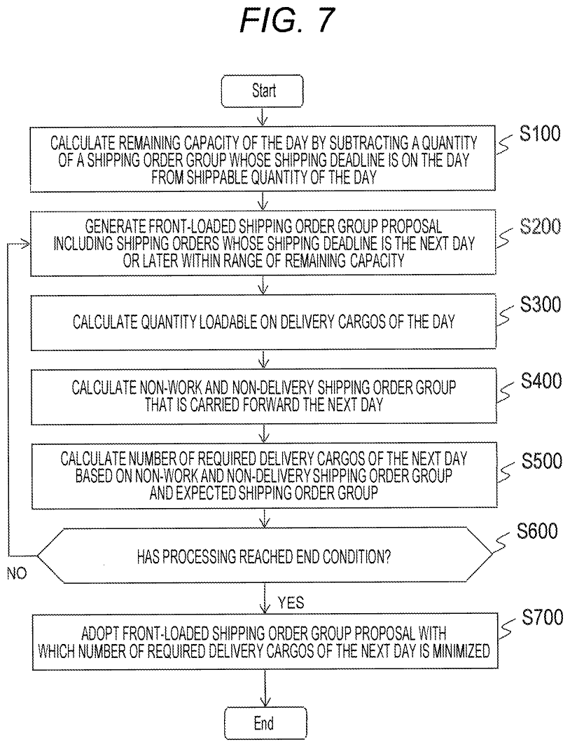

FIG. 7 is a flowchart showing processing executed by the control unit 130 according to the embodiment of the present invention. Hereinafter, one embodiment of the present invention will be described with reference to the flowchart.

Steps S100 to S200 are processing in the front-loaded shipping order determining unit 133.

In step S100, the front-loaded shipping order determining unit 133 calculates a remaining capacity of the day by subtracting a quantity of a shipping order group whose shipping deadline is on the day from a shippable quantity of the day. Here, in the present embodiment, a case where there is no shipping order whose shipping deadline is before the current day will be described. However, in a case where there is a shipping order whose shipping deadline is before the current day, it is possible to handle the case by taking the shipping deadline of such shipping orders as the current day, for example. In addition, in the present embodiment, a case where the quantity of the shipping order group with the shipping deadline of the day does not exceed the shippable quantity of the day will be described. However, in a case where the shippable quantity is smaller, for example, it is possible to handle the case by adjusting a value of the shippable quantity in advance or taking the shipping deadline of a part of the shipping orders as the next day or later.

In step S200, the front-loaded shipping order determining unit 133 generates a proposal of a front-loaded shipping order group including shipping orders whose shipping deadline is the next day or later within a range of the calculated remaining capacity. When the front-loaded shipping order group is generated, an order to be front-loaded may be randomly selected from an original shipping order group, or may be selected based on a predetermined rule, and the present invention does not limit the method.

Further, in the present embodiment, whether or not the shipping work of a certain shipping order group falls within the shipping work capability of the warehouse is determined from the quantity of each shipping order and the shippable quantity of the warehouse, but the present invention does not limit this determination method. For example, the determination may be made based on whether required work man-hours in each work process is equal to or less than input work man-hours, from information on a work process group required until shipment of each shipping order and work man-hours in each work process and information on operating time and a number of input work personnel in each work process.

Steps S300 to S400 are processing in the carry-forward quantity calculating unit 131.

In step S300, the carry-forward quantity calculating unit 131 first allocates the shipping order group whose shipping deadline is on the day extracted in step S100 to same-day delivery cargos. At this time, each shipping order is allocated to a delivery cargo of a matching delivery destination. In addition, allocation is made within a range in which a total quantity of the shipping order allocated to each delivery cargo does not exceed the loadable quantity of the delivery cargo.

Next, the carry-forward quantity calculating unit 131 allocates the front-loaded shipping order group generated in step S200 to the delivery cargos by the same process as described above. Here, in the present embodiment, whether or not a certain shipping order group can be loaded on a certain delivery cargo is determined based on the quantity of each order and the loadable quantity of the delivery cargo, but the present invention does not limit this determination method. For example, the loadability may be determined by solving a three-dimensional packing problem from information on a three-dimensional shape and a number of products included in each shipping order and information on a three-dimensional shape of a loading area of each delivery cargo.

In step S400, the carry-forward quantity calculating unit 131 extracts a shipping order group that have not been allocated to the delivery cargo in step S300 as a non-delivery shipping order group, and extracts a shipping order group not included in the front-loaded shipping order group among the shipping orders whose shipping deadline is on or after the next day as a non-work shipping order group.

Step S500 is a processing in the required cargo number calculating unit 132.

In step S500, the required cargo number calculating unit 132 first extracts a shipping order group whose shipping deadline is on the next day from the non-delivery shipping order group and the non-work shipping order group that have been extracted in step S400, and the expected shipping order group.

Then, the required cargo number calculating unit 132 calculates a number of required delivery cargos for delivering the extracted shipping order group. For example, in the present embodiment, the number of required delivery cargos is calculated by allocating each shipping order of the extracted shipping order group to a virtually generated delivery cargo. At this time, the required cargo number calculating unit 132 allocates only the shipping orders of the same delivery destination to each delivery cargo. In addition, the required cargo number calculating unit 132 allocates the shipping order within a range in which a total quantity of the order group allocated to each delivery cargo does not exceed the loadable quantity of the delivery cargo.

However, as in S400, the present invention does not limit a method of determining whether a certain shipping order group can be loaded on a certain delivery cargo.

Steps S600 to S700 are processing in the front-loaded shipping order determining unit 133.

In step S600, the front-loaded shipping order determining unit 133 determines whether or not the processing has reached a predetermined end condition. In a case where the processing has reached the predetermined end condition, the process proceeds to step S700. On the other hand, if the processing has not reached the end condition, the processing returns to step S200, and the front-loaded shipping order determining unit 133 generates a new proposal of the front-loaded shipping order group. As the end condition, for example, an upper limit value of required time of the entire processing illustrated in FIG. 7 or an upper limit value of the number of repetitions of step S200 may be used, but the present invention does not limit the definition of the end condition.

In step S700, the front-loaded shipping order determining unit 133 extracts, as a final front-loaded shipping order group, a proposal whose number of required delivery cargos is minimized, from a plurality of front-loaded shipping order group proposals generated in steps S200 to S500 and information on the number of required delivery cargos in each proposal.

Again, FIG. 1 is referenced. The output unit 140 displays information in the storage unit 120 and a processing result of the control unit 130 on a screen.

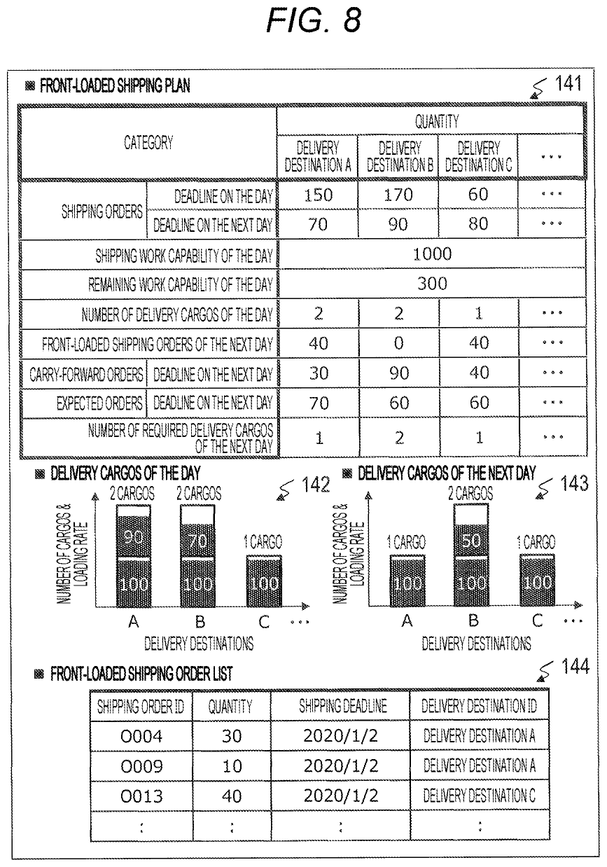

FIG. 8 is an explanatory diagram illustrating an example of a display screen output by the output unit 140 according to the embodiment of the present invention.

As illustrated in FIG. 8, the screen displayed by the output unit 140 includes, for example, a front-loaded shipping plan display area 141, a same-day delivery cargo number display area 142, an overnight delivery cargo number display area 143, and a front-loaded shipping order list display area 144. In the front-loaded shipping plan display area 141, a shipping order quantity, a front-loaded shipping order quantity, and the number of delivery cargos for each delivery destination are displayed as the processing result of the control unit 130.

In the same-day delivery cargo number display area 142 and the overnight delivery cargo number display area 143, the numbers of delivery cargos on the day and on the next day are respectively displayed. As illustrated in FIG. 8, not only the number of delivery cargos but also a loading rate of each delivery cargo may be displayed, for example. A list of the determined front-loaded shipping orders is displayed in the front-loaded shipping order list display area 144 as the processing result of the control unit 130.

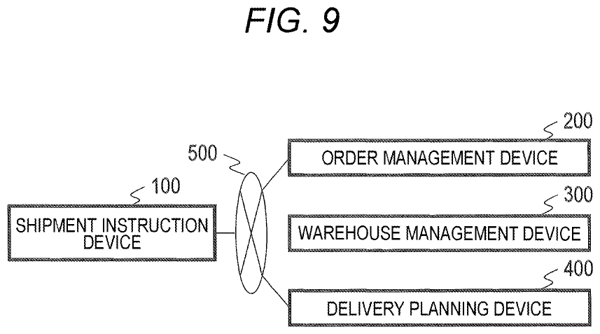

FIG. 9 is a schematic diagram of a shipment instruction system which is one embodiment of the present invention.

As illustrated, the shipment instruction system 900 includes a shipment instruction device 100, an order management device 200, a warehouse management device 300, and a delivery planning device 400, which can transmit and receive information via a network 500.

The order management device 200 transmits shipping order data to the shipment instruction device 100. The warehouse management device 300 transmits shippable quantity data of the warehouse to the shipment instruction device 100, and receives front-loaded shipping order data from the shipment instruction device 100. The delivery planning device 400 transmits delivery cargo data to the shipment instruction device 100 and receives the front-loaded shipping order data from the shipment instruction device 100.

Here, in the present embodiment, the shipping deadline, the shippable quantity, and the number of delivery cargos are defined and calculated on a daily basis such as the day and the next day, but this is an example of a predetermined period serving as a unit of definition and calculation, and the present invention does not limit this unit. For example, the shipping deadline, the shippable quantity, and the number of delivery cargos may be defined or calculated in units of several hours.

In addition, in the present embodiment, the information related to the received shipping orders (information stored in the shipping order information storage area 121) and the information related to the shipping order that has not been received yet but is expected to be received in the future (information stored in the expected shipping order information storage area 125) are treated separately, but these may be collectively treated as the shipping order information in practice. In addition, in a case where all the shipping orders to be shipped in the future to some extent such as one week later or one month later have been received and confirmed, for example, the above processing can be executed using only the received shipping order information.

In addition, when there are the received shipping orders and the expected shipping orders as in the present embodiment, the expected shipping order information may include information on order receipt probability and probability distribution of the quantity, in addition to the information on the delivery destination, the quantity, and the shipping deadline of each expected shipping order as illustrated in FIG. 6. In this case, the required cargo number calculating unit 132 may calculate the probability distribution of the number of required delivery cargos of the next day in step S500, and the front-loaded shipping order determining unit 133 may adopt a shipping order group proposal in which a statistical value calculated from the probability distribution of the number of required delivery cargos of the next day is minimized in step S700.

Furthermore, the storage unit 120 may further hold information on the number of delivery cargos that can be arranged on each day. In this case, in step S700, the front-loaded shipping order determining unit 133 may adopt a shipping order group proposal in which the statistical value does not exceed the number of delivery cargos that can be arranged. Specifically, for example, after step S500, the front-loaded shipping order determining unit 133 may determine whether the statistical value of the number of required delivery cargos calculated in step S500 is equal to or less than the number of delivery cargos that can be arranged, and exclude the shipping order group proposal that does not satisfy the condition from a target of the determination. As a result, it is possible to prepare a feasible shipping plan without additionally arranging a delivery cargo or the like.

Here, the statistical value calculated from the probability distribution of the number of required delivery cargos of the next day may be, for example, an expected value of the number of required delivery cargos of the next day (that is, a value at which the probability that the number of required delivery cargos exceeds the value is 1/2). However, if the number of actually required delivery cargos exceeds the number of delivery cargos that can be arranged, the cost may be affected by additional arrangement of delivery cargos, a review of the plan, and the like. In order to avoid such a situation, a statistical value other than the expected value may be used so that the probability of occurrence of such an excess of the number of delivery cargos is reduced. For example, a value at which the probability that the number of required delivery cargos exceeds the value is a predetermined probability smaller than 1/2 (for example, 20%) may be used as the statistical value. Alternatively, a maximum value or a mode value of the calculated number of required delivery cargos, a value calculated based on these values, or the like may be used as the statistical value. As a result, the number of actually required delivery cargos is less likely to exceed the number of delivery cargos that can be arranged, and a feasible shipping plan with reduced risk of an increase in cost can be easily prepared.

Further, the system according to the embodiment of the present invention may be configured as in the following.

(1) A shipment instruction device (for example, the shipment instruction device 100) includes a control unit (for example, the control unit 130) and a storage unit (for example, the storage unit 120), wherein the storage unit holds shipping order information (for example, at least one of information stored in the shipping order information storage area 121 and information stored in the expected shipping order information storage area 125) indicating a delivery destination, a quantity, and a shipping deadline of each shipping order, shipping work capability information (for example, information stored in the shipping work capability information storage area 122) indicating a shippable quantity of a warehouse in a predetermined period (for example, one day), delivery cargo information (for example, information stored in the delivery cargo information storage area 123) indicating a delivery cargo to each delivery destination in the predetermined period, and loadable capacity information (for example, information stored in the loadable capacity information storage area 124) indicating a loadable quantity of the delivery cargo, and the control unit: calculates, based on the shipping order information and the shipping work capability information, a remaining capacity from a difference between a shippable quantity during the predetermined period and a quantity of a shipping order whose shipping deadline arrives during the predetermined period, the remaining capacity being a remaining shippable quantity during the predetermined period (for example, step S100); generates a plurality of front-loaded shipping order group proposals including a shipping order whose shipping deadline arrives after the predetermined period within a range of the remaining capacity (for example, step S200); calculates a quantity loadable during the predetermined period based on the delivery cargo information and the loadable capacity information (for example, step S300); calculates a shipping order group to be delivered in a period after the predetermined period for each front-loaded shipping order group proposal, based on the quantity of the shipping order whose shipping deadline arrives in the predetermined period, the quantity of the front-loaded shipping order group proposal, and the quantity loadable in the predetermined period (for example, step S400); calculates a number of required delivery cargos for a quantity to be shipped in the period after the predetermined period based on a shipping order group to be delivered in the period after the predetermined period and the shipping order information (for example, step S500); and specifies, among the plurality of front-loaded shipping order group proposals, a front-loaded shipping order group proposal whose number of required delivery cargos is small (for example, step S700).

As a result, it is possible to prepare a shipping work instruction capable of reducing the number of delivery cargos.

(2) In the above (1), the shipping order information includes expected shipping order information (for example, information stored in the expected shipping order information storage area 125) including a delivery destination, a quantity, a shipping deadline, order certainty, and a probability distribution of the quantity of each shipping order expected to be received in the future, and the control unit: calculates a statistical value of the number of required delivery cargos based on the expected shipping order information; and specifies, among the plurality of front-loaded shipping order group proposals, a front-loaded shipping order group proposal whose statistical value of the number of required delivery cargos is small.

As a result, it is possible to prepare a shipping work instruction capable of reducing the number of delivery cargos in consideration of expected receipt of shipping orders in the future.

(3) In the above (2), the storage unit further holds information on the number of delivery cargos that can be arranged in each period, and the control unit specifies, among the plurality of front-loaded shipping order group proposals, a front-loaded shipping order group proposal in which a statistical value of the number of required delivery cargos in a period after the predetermined period does not exceed a number of delivery cargos that can be arranged in a period after the predetermined period.

As a result, it is possible to prepare a shipping work instruction capable of reducing the number of delivery cargos in consideration of expected receipt of shipping orders in the future.

(4) In the above (2), the statistical value of the number of required delivery cargos is an expected value of the number of required delivery cargos.

As a result, it is possible to prepare a shipping work instruction capable of reducing the number of delivery cargos in consideration of expected receipt of shipping orders in the future.

(5) In the above (2), the statistical value of the number of required delivery cargos is a value at which a probability at which the number of required delivery cargos exceeds the value is a predetermined probability smaller than 1/2.

As a result, a feasible shipping plan with reduced risk of an increase in cost can be easily prepared.

Note that the present invention is not limited to the above-described embodiment, and includes various modifications. For example, the above-described embodiment has been described in detail for better understanding of the present invention, and is not necessarily limited to those having all the configurations in the description. Further, a part of one configuration of a certain embodiment can be replaced with a configuration of a different embodiment, and a configuration of one embodiment can be added to a configuration of a different embodiment. In addition, it is possible to add, delete, and replace other configurations for a part of the configuration of each embodiment.

In addition, some or all of the above-described configurations, functions, processing units, processing means, and the like may be realized as hardware, for example, by configuring with an integrated circuit. In addition, each of the above-described configurations, functions, and the like may be realized by software by a processor interpreting and executing a program for realizing each function. Information such as a program, a table, and a file for realizing each function can be stored in a storage device such as a nonvolatile semiconductor memory, a hard disk drive, and a solid state drive (SSD), or a computer-readable non-transitory data storage medium such as an IC card, an SD card, and a DVD.

In addition, the control lines and the information lines that are considered to be necessary for the description are illustrated, and all of the control lines and the information lines on the product are not necessarily shown. In practice, it may be considered that almost all the configurations are connected to each other.

1. A shipment instruction device comprising:
a control unit and a storage unit,
wherein
the storage unit holds shipping order information indicating a delivery destination, a quantity, and a shipping deadline of each shipping order, shipping work capability information indicating a shippable quantity of a warehouse in a predetermined period, delivery cargo information indicating a delivery cargo to each delivery destination in the predetermined period, and loadable capacity information indicating a loadable quantity of the delivery cargo, and
the control unit:
calculates, based on the shipping order information and the shipping work capability information, a remaining capacity from a difference between a shippable quantity during the predetermined period and a quantity of a shipping order whose shipping deadline arrives during the predetermined period, the remaining capacity being a remaining shippable quantity during the predetermined period;
generates a plurality of front-loaded shipping order group proposals including a shipping order whose shipping deadline arrives after the predetermined period within a range of the remaining capacity;
calculates a quantity loadable during the predetermined period based on the delivery cargo information and the loadable capacity information;
calculates a shipping order group to be delivered in a period after the predetermined period for each front-loaded shipping order group proposal, based on the quantity of the shipping order whose shipping deadline arrives in the predetermined period, the quantity of the front-loaded shipping order group proposal, and the quantity loadable in the predetermined period;
calculates a number of required delivery cargos for a quantity to be shipped in the period after the predetermined period based on a shipping order group to be delivered in the period after the predetermined period and the shipping order information; and
specifies, among the plurality of front-loaded shipping order group proposals, a front-loaded shipping order group proposal whose number of required delivery cargos is small.

2. The shipment instruction device according to claim 1, wherein
the shipping order information includes expected shipping order information including a delivery destination, a quantity, a shipping deadline, order certainty, and a probability distribution of the quantity of each shipping order expected to be received in the future, and
the control unit:
calculates a statistical value of the number of required delivery cargos based on the expected shipping order information; and
specifies, among the plurality of front-loaded shipping order group proposals, a front-loaded shipping order group proposal whose statistical value of the number of required delivery cargos is small.

3. The shipment instruction device according to claim 2, wherein
the storage unit further holds information on the number of delivery cargos that can be arranged in each period, and
the control unit specifies, among the plurality of front-loaded shipping order group proposals, a front-loaded shipping order group proposal in which a statistical value of the number of required delivery cargos in a period after the predetermined period does not exceed a number of delivery cargos that can be arranged in a period after the predetermined period.

4. The shipment instruction device according to claim 2, wherein
the statistical value of the number of required delivery cargos is an expected value of the number of required delivery cargos.

5. The shipment instruction device according to claim 2, wherein
the statistical value of the number of required delivery cargos is a value at which a probability at which the number of required delivery cargos exceeds the value is a predetermined probability smaller than 1/2.

6. A shipment instruction method executed by a shipment instruction device, wherein
the shipment instruction device includes a control unit and a storage unit,
the storage unit holds shipping order information indicating a delivery destination, a quantity, and a shipping deadline of each shipping order, shipping work capability information indicating a shippable quantity of a warehouse in a predetermined period, delivery cargo information indicating a delivery cargo to each delivery destination in the predetermined period, and loadable capacity information indicating a loadable quantity of the delivery cargo, and
the shipment instruction method comprises:
a first procedure in which the control unit calculates, based on the shipping order information and the shipping work capability information, a remaining capacity from a difference between a shippable quantity during the predetermined period and a quantity of a shipping order whose shipping deadline arrives during the predetermined period, the remaining capacity being a remaining shippable quantity during the predetermined period;
a second procedure in which the control unit generates a plurality of front-loaded shipping order group proposals including a shipping order whose shipping deadline arrives after the predetermined period within a range of the remaining capacity;
a third procedure in which the control unit calculates a quantity loadable during the predetermined period based on the delivery cargo information and the loadable capacity information;
a fourth procedure in which the control unit calculates a shipping order group to be delivered in a period after the predetermined period for each front-loaded shipping order group proposal, based on the quantity of the shipping order whose shipping deadline arrives in the predetermined period, the quantity of the front-loaded shipping order group proposal, and the quantity loadable in the predetermined period;
a fifth procedure in which the control unit calculates a number of required delivery cargos for a quantity to be shipped in the period after the predetermined period based on a shipping order group to be delivered in the period after the predetermined period and the shipping order information; and
a sixth procedure in which the control unit specifies, among the plurality of front-loaded shipping order group proposals, a front-loaded shipping order group proposal whose number of required delivery cargos is small.

7. The shipment instruction method according to claim 6, wherein
the shipping order information includes expected shipping order information including a delivery destination, a quantity, a shipping deadline, order certainty, and a probability distribution of the quantity of each shipping order expected to be received in the future,
in the fifth procedure, the control unit calculates a statistical value of the number of required delivery cargos based on the expected shipping order information, and
in the sixth procedure, the control unit specifies, among the plurality of front-loaded shipping order group proposals, a front-loaded shipping order group proposal whose statistical value of the number of required delivery cargos is small.

8. The shipment instruction method according to claim 7, wherein
the storage unit further holds information on the number of delivery cargos that can be arranged in each period, and
in the sixth procedure, the control unit specifies, among the plurality of front-loaded shipping order group proposals, a front-loaded shipping order group proposal in which a statistical value of the number of required delivery cargos in a period after the predetermined period does not exceed a number of delivery cargos that can be arranged in a period after the predetermined period.

9. The shipment instruction method according to claim 7, wherein
the statistical value of the number of required delivery cargos is an expected value of the number of required delivery cargos.

10. The shipment instruction method according to claim 7, wherein
the statistical value of the number of required delivery cargos is a value at which a probability at which the number of required delivery cargos exceeds the value is a predetermined probability smaller than 1/2.
